(19) United States
(12) Patent Application Publication
(10) Pub. No.: US 2025/0106117 A1
(43) Pub. Date: Mar. 27, 2025

(54) SYSTEMS AND METHODS FOR SECURING AND EMULATING OF COMPUTING SYSTEM CONFIGURATIONS

(71) Applicant: BANK OF AMERICA CORPORATION, Charlotte, NC (US)

(72) Inventors: Narsing Raj, Hyderabad (IN); John Bilton Kommu, Secunderabad (IN); Ashok Kumar, Hyderabad (IN); Aashish Chandrahas Vinherkar, Mumbai (IN); Venkata Lakshmi Sai Siva Kumar Devulapalli, Hyderabad (IN)

(73) Assignee: BANK OF AMERICA CORPORATION, Charlotte, NC (US)

(21) Appl. No.: 18/371,601

(22) Filed: Sep. 22, 2023

(51) Int. Cl. H04L 41/14; H04L 9/00; H04L 41/0869

(52) U.S. Cl. CPC H04L 41/145; H04L 9/50; H04L 41/0869

(57) ABSTRACT

Systems, computer program products, and methods are described herein for securing and emulating computing system configurations. The present disclosure is configured to identify at least one potential configuration for at least one system component; generate at least one configuration delta for the at least one potential configuration; apply the at least one configuration delta to a configuration delta processing engine; generate, by the configuration delta processing engine, at least one configuration delta processing engine output; apply the at least one configuration delta processing engine output to a configuration emulator engine; output, by the configuration emulator engine, at least one configuration simulation; apply the at least one configuration simulation to a configuration management component, wherein the configuration management component comprises a component configuration distributed ledger; and update the component configuration distributed ledger with the at least one configuration simulation.

### TECHNOLOGICAL FIELD

Example embodiments of the present disclosure relate to securing and emulating computing system configurations.

### BACKGROUND

Computer program systems and networks face many issues when they execute configuration(s) (or changes) to its components and elements without first determining whether the configurations should be implemented. The issue is further exacerbated when such configurations may accidentally or intentionally cause other components within the computer system to stop working entirely and/or partially, which may in turn lead to lowered processing speeds, lowered memory storage, and/or the like. Thus, there exists a need for a system (or method) that simplifies and streamlines the configurations that may occur within a computer system environment, including each of the components that may be directly and indirectly affected by such configurations. Therefore, a system (or method) is needed that can improve computer system processing speeds and computer storage capacity automatically, dynamically, intelligently, and reliably.

Applicant has identified a number of deficiencies and problems associated with determining and emulating changes and events within computing systems, and the affected components of those changes (both direct and indirect affected components). Through applied effort, ingenuity, and innovation, many of these identified problems have been solved by developing solutions that are included in embodiments of the present disclosure, many examples of which are described in detail herein BRIEF SUMMARY

Systems, methods, and computer program products are provided for securing and emulating computing system configurations.

In one aspect, a system for securing and emulating computing system configurations is provided. In some embodiments, the system may comprise: a memory device with computer-readable program code stored thereon; at least one processing device, wherein executing the computer-readable code is configured to cause the at least one processing device to perform the following operations: identify at least one potential configuration for at least one system component; generate at least one configuration delta for the at least one potential configuration; apply the at least one configuration delta to a configuration delta processing engine; generate, by the configuration delta processing engine, at least one configuration delta processing engine output; apply the at least one configuration delta processing engine output to a configuration emulator engine; output, by the configuration emulator engine, at least one configuration simulation; apply the at least one configuration simulation to a configuration management component, wherein the configuration management component comprises a component configuration distributed ledger; and update the component configuration distributed ledger with the at least one configuration simulation.

In some embodiments, the configuration delta processing engine comprises at least one of a simulation aggregator component, an elastic data feed component, a resource usage mapping component, a stability assessment component, a configuration cognition component, or an autonomous capacity planning component.

In some embodiments, the at least one configuration delta processing engine output comprises at least one of a potential configuration definition, a configuration group identifier, an anomaly, a usage heat map, a desired result attribute, a primary configuration identifier, or a resource capacity instruction.

In some embodiments, the configuration emulator engine comprises at least one of a real time synchronizer component, a configuration playbook, a model environment stack, or an infrastructure manager component.

In some embodiments, the at least one configuration simulation comprises at least one script.

In some embodiments, the at least one configuration delta comprises at least one a base identifier, and wherein the base identifier is associated with a new system component or an updated system component.

In some embodiments, updating the component configuration distributed ledger with the at least one configuration simulation comprises: identify a plurality of validating entities within a distributed network, wherein the plurality of validating entities is associated with the at least one system component; generate a consensus algorithm for the component configuration distributed ledger, wherein the consensus algorithm comprises a consensus threshold; and receive a plurality of validation responses from the plurality of validating entities, wherein the plurality of validation responses is compared to the consensus threshold, update, in the instance where the plurality of validation responses meet or exceed the consensus threshold, the component configuration distributed ledger with the at least one configuration simulation. In some embodiments, the configuration management component comprises at least one smart contract associated with the at least one potential configuration, and wherein the at least one smart contract triggers the updating of the component configuration distributed ledger.

Similarly, and as a person of skill in the art will understand, each of the features, functions, and advantages provided herein with respect to the system disclosed hereinabove may additionally be provided with respect to a computer-implemented method and computer program product. Such embodiments are provided for exemplary purposes below and are not intended to be limited.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for securing and emulating computing system configurations, in accordance with an embodiment of the disclosure;

FIG. 2 illustrates an exemplary machine learning (ML) subsystem architecture, in accordance with an embodiment of the disclosure;

FIG. 3 illustrates a process flow for securing and emulating computing system configurations, in accordance with an embodiment of the disclosure;

FIG. 4 illustrates a process flow for updating the component configuration distributed ledger, in accordance with an embodiment of the disclosure; and

FIG. 5 illustrates an exemplary computing environment with associated components for securing and emulating computing system configurations, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, a “resource” may generally refer to objects, products, devices, and the like, and/or the ability and opportunity to access and use the same. Some example implementations herein contemplate property stored and/or maintained by a third-party entity. For purposes of this disclosure, a resource is typically stored in a resource repository—a storage location where one or more resources are organized, stored and retrieved electronically using a computing device.

Computer program systems and networks face many issues when they execute configuration(s) (or changes) to its components and elements without first determining whether the configurations should be implemented. The issue is further exacerbated when such configurations may accidentally or intentionally cause other components within the computer system to stop working entirely and/or partially, which may in turn lead to lowered processing speeds, lowered memory storage, and/or the like. Thus, there exists a need for a system (or method) that simplifies and streamlines the configurations that may occur within a computer system environment, including each of the components that may be directly and indirectly affected by such configurations. Therefore, a system (or method) is needed that can improve computer system processing speeds and computer storage capacity automatically, dynamically, intelligently, and reliably.

Thus, the disclosure provides a system, method, or computer program product comprising a distributed ledger for each configuration to a computing system environment, both the small and large configurations and changes that may occur and their associated effects. Additionally, the disclosure further comprises an optimizer component to determine which—of the configurations—likely caused issues within the computing system environment. The disclosure also comprises a configuration emulator engine component configured to recreate the computing system environment in real time with the configurations and with a configuration playbook that comprises previously generated emulated configuration sets that may comprise both acceptable and, in some embodiments, unacceptable configurations. Based on each of these components, the system may determine which configurations to implement in the actual computing system environment and which to disallow, while also keeping a complete record of each configuration, based on the determination of which configuration(s) is optimal for the overall computing system environment.

Accordingly, the present disclosure provides for identifying at least one potential configuration (e.g., potential change for a component or plurality of components within the computer system environment) for at least one system component; generating at least one configuration delta for the at least one potential configuration; applying the at least one configuration delta to a configuration delta processing engine (e.g., to determine a suggested optimal potential configuration and/or group of configurations); and generating, by the configuration delta processing engine, at least one configuration delta processing engine output. Further, the present disclosure may provide for applying the at least one configuration delta processing engine output to a configuration emulator engine; outputting, by the configuration emulator engine, at least one configuration simulation (e.g., of the chosen optimal configuration and/or all the potential configurations); applying the at least one configuration simulation to a configuration management component, wherein the configuration management component comprises a component configuration distributed ledger (e.g., a block chain of all the configurations, whereby each block chain is associated with a component within the computer system environment); and updating the component configuration distributed ledger with the at least one configuration simulation.

What is more, the present disclosure provides a technical solution to a technical problem. As described herein, the technical problem includes, but is not limited to, determining and emulating changes and events within computing systems, and the affected components of those changes (both direct and indirect affected components). The technical solution presented herein allows for a system configured to determine optimal configuration(s) to the computer system environment before the configurations are executed or produced and tracking/recording each configuration to each component within the computer system environment. In particular, the system is an improvement over existing solutions to the determining and implementing optimal configurations to computer system environment components, (i) with fewer steps to achieve the solution, thus reducing the amount of computing resources, such as processing resources, storage resources, network resources, and/or the like, that are being used, (ii) providing a more accurate solution to problem, thus reducing the number of resources required to remedy any errors made due to a less accurate solution, (iii) removing manual input and waste from the implementation of the solution, thus improving speed and efficiency of the process and conserving computing resources, (iv) determining an optimal amount of resources that need to be used to implement the solution, thus reducing network traffic and load on existing computing resources. Furthermore, the technical solution described herein uses a rigorous, computerized process to perform specific tasks and/or activities that were not previously performed. In specific implementations, the technical solution bypasses a series of steps previously implemented, thus further conserving computing resources.

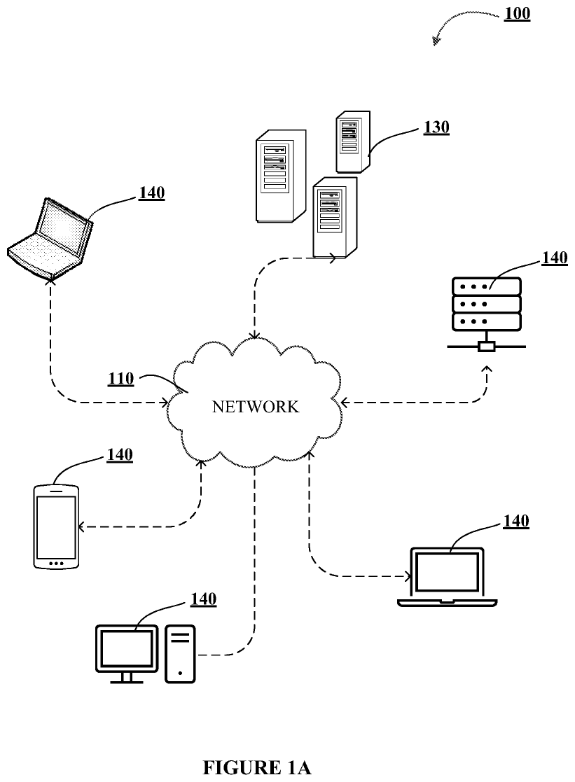

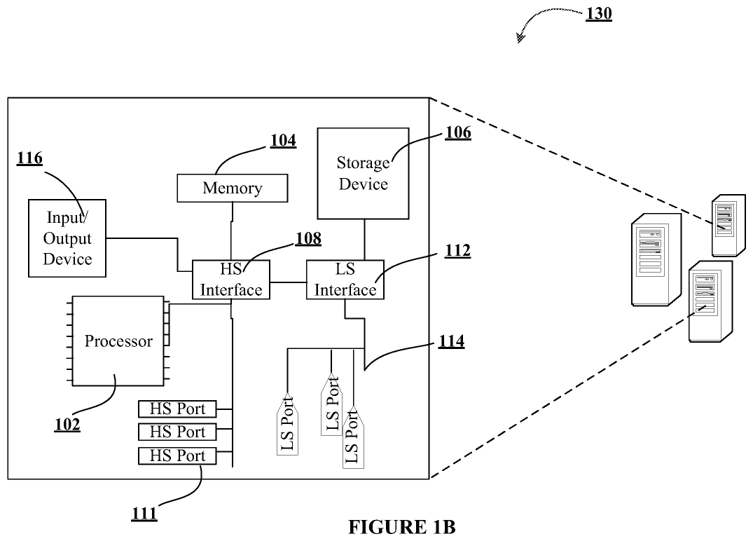

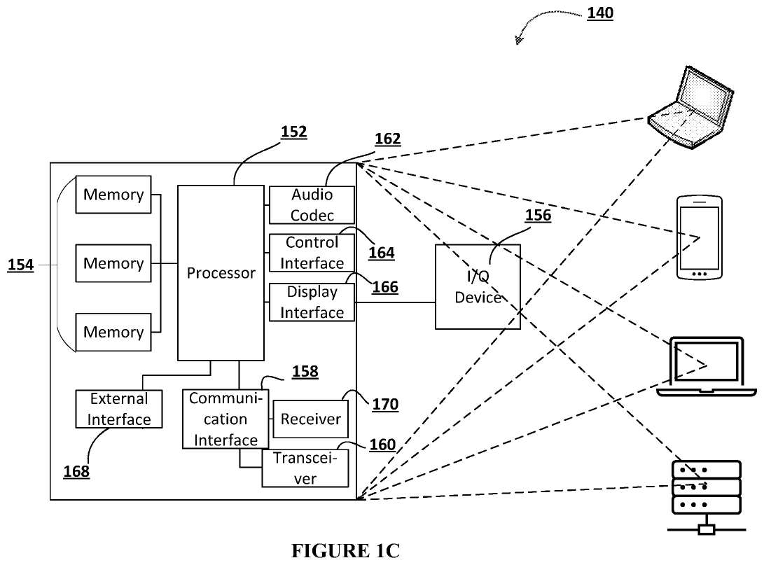

FIGS. 1A-1C illustrate technical components of an exemplary distributed computing environment for securing and emulating computing system configurations 100, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, entertainment consoles, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, input/output (I/O) device 116, and a storage device 110. The system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer- or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation- and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

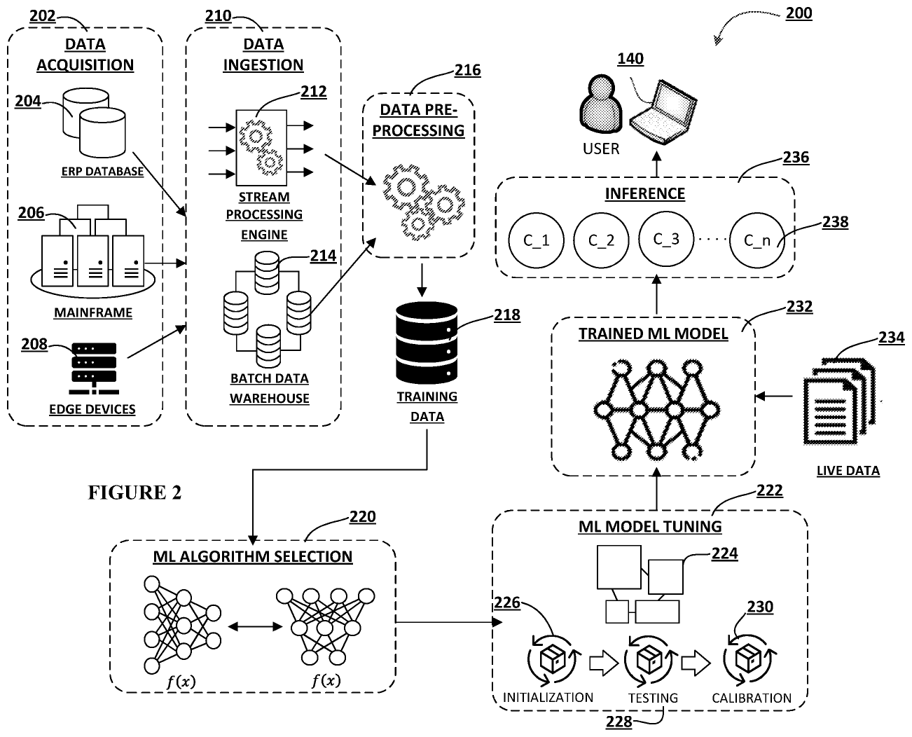

FIG. 2 illustrates an exemplary machine learning (ML) subsystem architecture 200, in accordance with an embodiment of the disclosure. The machine learning subsystem 200 may include a data acquisition engine 202, data ingestion engine 210, data pre-processing engine 216, ML model tuning engine 222, and inference engine 236.

The data acquisition engine 202 may identify various internal and/or external data sources to generate, test, and/or integrate new features for training the machine learning model 224. These internal and/or external data sources 204, 206, and 208 may be initial locations where the data originates or where physical information is first digitized. The data acquisition engine 202 may identify the location of the data and describe connection characteristics for access and retrieval of data. In some embodiments, data is transported from each data source 204, 206, or 208 using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, the these data sources 204, 206, and 208 may include Enterprise Resource Planning (ERP) databases that host data related to day-to-day business activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like. The data acquired by the data acquisition engine 202 from these data sources 204, 206, and 208 may then be transported to the data ingestion engine 210 for further processing.

Depending on the nature of the data imported from the data acquisition engine 202, the data ingestion engine 210 may move the data to a destination for storage or further analysis. Typically, the data imported from the data acquisition engine 202 may be in varying formats as they come from different sources, including RDBMS, other types of databases, S3 buckets, CSVs, or from streams. Since the data comes from different places, it needs to be cleansed and transformed so that it can be analyzed together with data from other sources. At the data ingestion engine 202, the data may be ingested in real-time, using the stream processing engine 212, in batches using the batch data warehouse 214, or a combination of both. The stream processing engine 212 may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse 214 collects and transfers data in batches according to scheduled intervals, trigger events, or any other logical ordering.

In machine learning, the quality of data and the useful information that can be derived therefrom directly affects the ability of the machine learning model 224 to learn. The data pre-processing engine 216 may implement advanced integration and processing steps needed to prepare the data for machine learning execution. This may include modules to perform any upfront, data transformation to consolidate the data into alternate forms by changing the value, structure, or format of the data using generalization, normalization, attribute selection, and aggregation, data cleaning by filling missing values, smoothing the noisy data, resolving the inconsistency, and removing outliers, and/or any other encoding steps as needed.

In addition to improving the quality of the data, the data pre-processing engine 216 may implement feature extraction and/or selection techniques to generate training data 218. Feature extraction and/or selection is a process of dimensionality reduction by which an initial set of data is reduced to more manageable groups for processing. A characteristic of these large data sets is a large number of variables that require a lot of computing resources to process. Feature extraction and/or selection may be used to select and/or combine variables into features, effectively reducing the amount of data that must be processed, while still accurately and completely describing the original data set. Depending on the type of machine learning algorithm being used, this training data 218 may require further enrichment. For example, in supervised learning, the training data is enriched using one or more meaningful and informative labels to provide context so a machine learning model can learn from it. For example, labels might indicate whether a photo contains a bird or car, which words were uttered in an audio recording, or if an x-ray contains a tumor. Data labeling is required for a variety of use cases including computer vision, natural language processing, and speech recognition. In contrast, unsupervised learning uses unlabeled data to find patterns in the data, such as inferences or clustering of data points.

The ML model tuning engine 222 may be used to train a machine learning model 224 using the training data 218 to make predictions or decisions without explicitly being programmed to do so. The machine learning model 224 represents what was learned by the selected machine learning algorithm 220 and represents the rules, numbers, and any other algorithm-specific data structures required for classification. Selecting the right machine learning algorithm may depend on a number of different factors, such as the problem statement and the kind of output needed, type and size of the data, the available computational time, number of features and observations in the data, and/or the like. Machine learning algorithms may refer to programs (math and logic) that are configured to self-adjust and perform better as they are exposed to more data. To this extent, machine learning algorithms are capable of adjusting their own parameters, given feedback on previous performance in making prediction about a dataset.

The machine learning algorithms contemplated, described, and/or used herein include supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), and/or any other suitable machine learning model type. Each of these types of machine learning algorithms can implement any of one or more of a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial least squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and/or the like.

To tune the machine learning model, the ML model tuning engine 222 may repeatedly execute cycles of experimentation 226, testing 228, and tuning 230 to optimize the performance of the machine learning algorithm 220 and refine the results in preparation for deployment of those results for consumption or decision making. To this end, the ML model tuning engine 222 may dynamically vary hyperparameters each iteration (e.g., number of trees in a tree-based algorithm or the value of alpha in a linear algorithm), run the algorithm on the data again, then compare its performance on a validation set to determine which set of hyperparameters results in the most accurate model. The accuracy of the model is the measurement used to determine which set of hyperparameters is best at identifying relationships and patterns between variables in a dataset based on the input, or training data 218. A fully trained machine learning model 232 is one whose hyperparameters are tuned and model accuracy maximized.

The trained machine learning model 232, similar to any other software application output, can be persisted to storage, file, memory, or application, or looped back into the processing component to be reprocessed. More often, the trained machine learning model 232 is deployed into an existing production environment to make practical business decisions based on live data 234. To this end, the machine learning subsystem 200 uses the inference engine 236 to make such decisions. The type of decision-making may depend upon the type of machine learning algorithm used. For example, machine learning models trained using supervised learning algorithms may be used to structure computations in terms of categorized outputs (e.g., C_1, C_2 . . . C_n 238) or observations based on defined classifications, represent possible solutions to a decision based on certain conditions, model complex relationships between inputs and outputs to find patterns in data or capture a statistical structure among variables with unknown relationships, and/or the like. On the other hand, machine learning models trained using unsupervised learning algorithms may be used to group (e.g., C_1, C_2 . . . C_n 238) live data 234 based on how similar they are to one another to solve exploratory challenges where little is known about the data, provide a description or label (e.g., C_1, C_2 . . . C_n 238) to live data 234, such as in classification, and/or the like. These categorized outputs, groups (clusters), or labels are then presented to the user input system 130. In still other cases, machine learning models that perform regression techniques may use live data 234 to predict or forecast continuous outcomes.

It will be understood that the embodiment of the machine learning subsystem 200 illustrated in FIG. 2 is exemplary and that other embodiments may vary. As another example, in some embodiments, the machine learning subsystem 200 may include more, fewer, or different components.

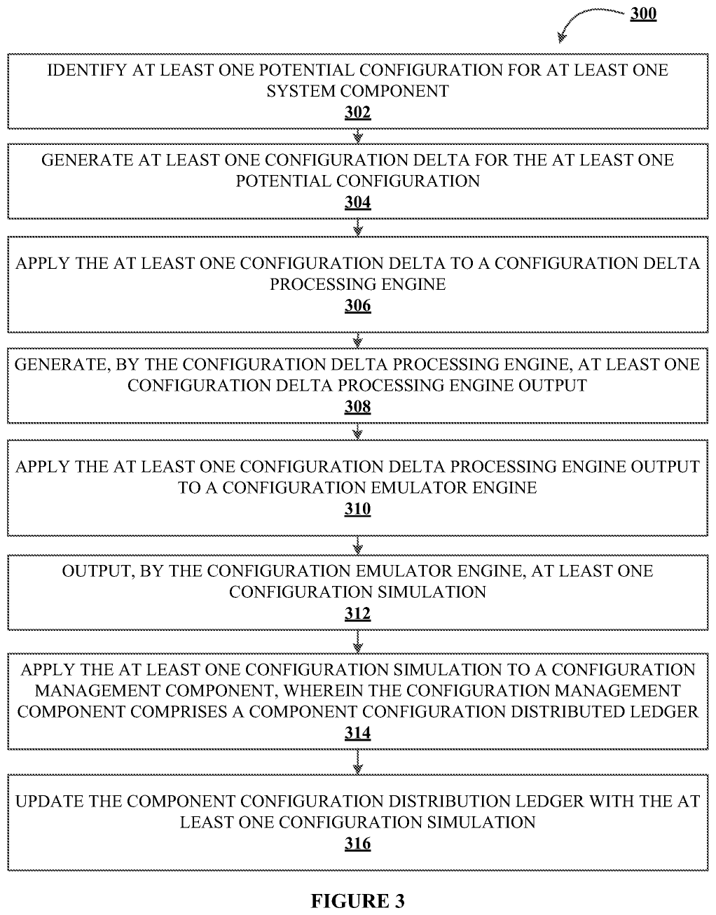

FIG. 3 illustrates a process flow 300 for securing and emulating computing system configurations, in accordance with an embodiment of the disclosure. In some embodiments, a system (e.g., similar to one or more of the systems described herein with respect to FIGS. 1A-1C and 2) may perform one or more of the steps of process flow 300. For example, a system (e.g., the system 130 described herein with respect to FIG. 1A-1C) may perform the steps of process 300.

As shown in block 302, the process flow 300 may include the step of identifying at least one potential configuration for at least one system component. For example, the system may identify at least one potential configuration to at least one component of a computer system. As used herein, such a potential configuration refers to a not-yet executed change or not-yet executed update to the at least one component. In some embodiments, the not-yet executed change or update may comprise an update to a software component of the computer system (such as updates or changes to a script file, and/or the like), a change or update to a hardware component, a change or update to software or hardware for a network, and/or the like.

As used herein, the process(es) described herein with respect to the potential configuration(s) may occur before the configuration(s) are implemented and executed on the computer system component(s). In this manner, the system is configured to determine which of the potential configuration(s) should be executed to create the most optimal configured computer system components and overall computer system. Such improvements and implementations are discussed in further detail herein.

In some embodiments, the system may identify the at least one potential configuration based on receiving and/or identifying a requested change to a particular computer system component from a user device associated with a client of the system (e.g., an information technology (IT) user of a client), a manager of the system, the system itself (e.g., based on the system itself making a suggestion of an optimal potential configuration, and/or the like), and/or the like. In some embodiments, such a potential configuration may be transmitted from a user device to the system, such as over a network (e.g., network 110 of FIG. 1A), and/or the like. In some embodiments, the system itself may identify the potential configuration(s) based on identifying potential changes that have not yet been executed, but have been input to occur within the computer system at a future time. In some embodiments, each of the potential configuration(s) may be identified by comparing a current computer system component against a previous edition or version of the computer system component, and identifying the potential configurations or changes that have been input or requested (e.g., such as new lines of code, additional files, additional hardware components, subtracted lines of code, subtracted files, subtracted hardware components, and/or the like).

As show in block 304, the process flow 300 may include the step of generating at least one configuration delta for the at least one potential configuration. For example, the system may generate a configuration delta for the at least one potential configuration(s) based on comparing the previous edition or version of the computer system component and the computer system component with the at least one potential configuration(s). Such a configuration delta may then indicate a level of change and/or numerical marker of the change for the potential configuration(s) for each computer system component, individually, based on the previously published or executed computer system component. In this manner, the configuration delta for each computer system component comprising a potential configuration may show the overall level of changes occurring based on the potential configuration(s) currently identified by the system for each computer system component, individually.

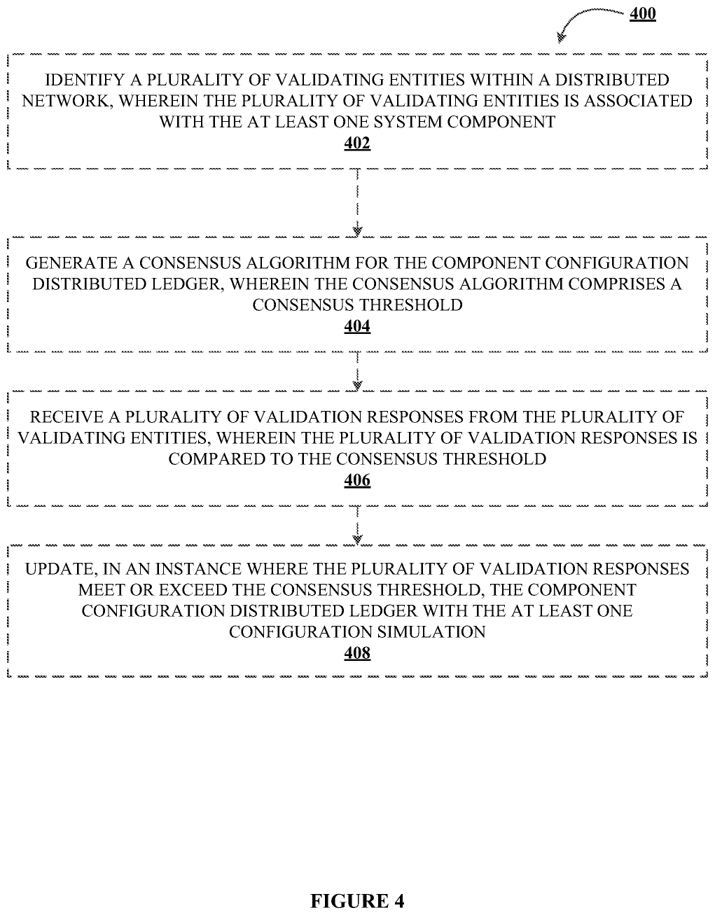

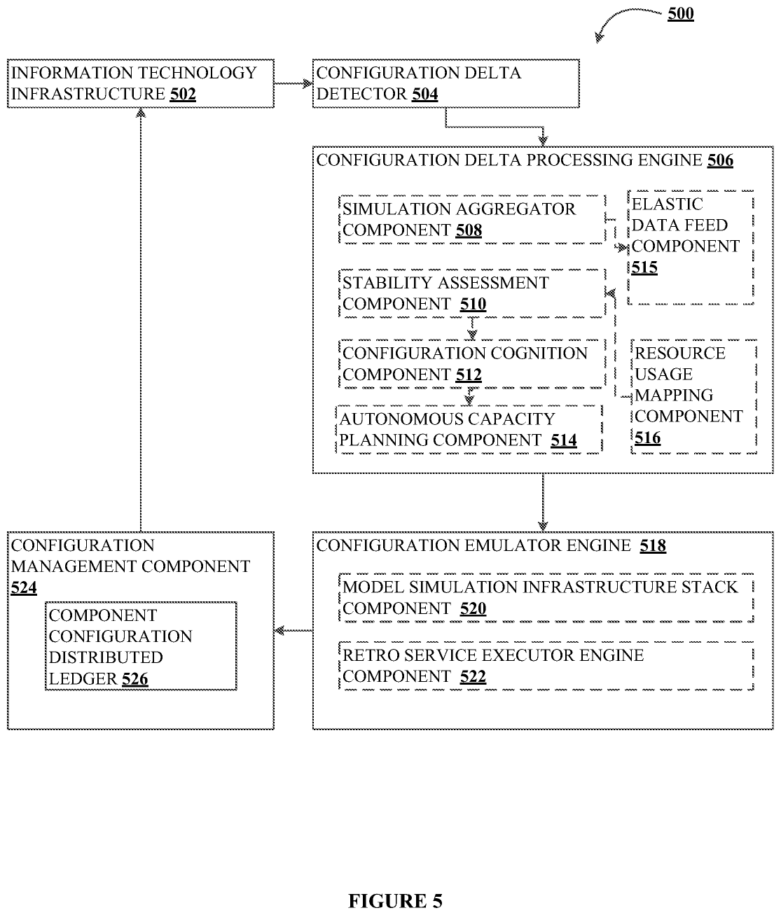

In some embodiments, the at least one configuration delta comprises at least one a base identifier, and wherein the base identifier is associated with a new system component or an updated system component. For example, and in some embodiments, the base identifier may uniquely and individually identify a computer system component's versions or editions based on executed configuration(s) to the computer system component. For example, the base identifier may comprise at least a “BASE 0” to identify the original version or edition of the computer system component, and whereby a “BASE 1,” “BASE 2,” . . . “BASE N” base identifier may identify a first version, a second version, . . . an nth version of the computer system component after a first configuration, a second configuration, an nth configuration, respectively. In some embodiments, such a base identifier may be used within a distributed ledger to identify which configuration is associated with which version of the computer system component for each block within the distributed ledger. Such an embodiment is discussed in further detail below with respect to FIGS. 4 and 5.

As shown in block 306, the process flow 300 may include the step of applying the at least one configuration delta to a configuration delta processing engine. For example, the system may apply the configuration delta(s), along with the data of each configuration delta (e.g., each associated potential configuration for each configuration delta, each identified computer system component, and/or the like), to a configuration delta processing engine which is configured to analyze the configuration delta(s) and associated data.

As used herein, the configuration delta processing engine refers to a computing engine configured to at least determine an optimal configuration for a computer system component. Additionally, and/or alternatively, the configuration delta processing engine may determine secondary computer system component resources that may be changed or updated based on the optimal configuration (e.g., such as but not limited to a recommended increase or decrease in resource capacity, such as a computer component's storage capacity, internal memory, random access memory storage, cache memory, read only memory, non-volatile memory, and/or the like).

In some embodiments, the configuration delta processing engine may comprise at least one of a simulation aggregator component, an elastic data feed component, a resource usage mapping component, a stability assessment component, a configuration cognition component, or an autonomous capacity planning component. In some embodiments, each of the components described herein with respect to the configuration delta processing engine may be configured to generate specific outputs, such as but not limited to at least one of a potential configuration definition, a configuration group identifier, an anomaly, a usage heat map, a desired result attribute, a primary configuration identifier, or a resource capacity instruction, which is described in further detail below and with respect to FIG. 5.

As shown in block 308, the process flow 300 may include the step of generating—by the configuration delta processing engine—at least one configuration delta processing engine output. For example, the system (via the configuration delta processing engine) at least one configuration delta processing engine out, whereby such a configuration delta processing engine output may comprise at least one of a potential configuration definition, a configuration group identifier, an anomaly, a usage heat map, a desired result attribute, a primary configuration identifier, and/or a resource capacity instruction.

As used herein, the potential configuration definition refers to a set description of each potential configuration, whereby the set description may comprise a universal description known and understood by the system and its engines and components. In some embodiments, each of the configuration definition(s) of the at least one potential configuration(s) may be aggregated, such that each potential configuration for an identified computer system component may be aggregated together to form an overall definition of all the potential configuration(s). In some embodiments, the configuration definitions may comprise the same or similar keywords, terms, phrases, and/or the like to describe the same or similar potential configurations.

As used herein, the configuration group identifier refers to a grouping of the potential configuration(s) identified at each time, whereby the potential configuration(s) may be simplified (e.g., such as based on the configuration definitions aggregated) and grouped together based on similar or same characteristics. In some embodiments, the grouping of configuration sets for the potential configurations may be based on the same or similar keywords, terms, phrases, and/or the like within the configuration definitions, which may indicate the same or similar characteristics within the potential configurations. In some embodiments, the configuration group identifiers may comprise a unique identifier for each grouping of configuration(s) (e.g., potential configuration(s)), such that the system may individually identify each grouping of configuration(s) efficiently and accurately. In some embodiments, the simulation aggregator component, which is described in further detail below with respect to FIG. 5, may generate the configuration group identifier(s).

As used herein, an anomaly refers to any detected anomaly(ies) for each potential configuration(s), whereby such an anomaly may comprise but is not limited to an anomaly in executing the potential configuration (such as an inability to run the potential configuration to get the desired result, functional anomalies, logical anomalies, workflow anomalies, and/or the like). In some embodiments, the anomaly(ies) may be generated by an elastic data feed component, such as that shown and described in further detail below with respect to FIG. 5. In some such embodiments, the elastic data feed component is configured to retrieve data feeds (e.g., from a component associated with the configuration(s), such as from a database of previous configurations generated and updated by the system, from an application programming interface (API) that is configured to transmit data regarding configuration(s) from a configuration source to the system, and/or the like) through an elastic search of the configuration data sets (the grouping(s) of configuration(s)) for detecting any anomalies. As used herein, the data feeds comprise up-to-date and in real-time data on configuration(s) and their associated effects and potential anomalies.

As used herein, a usage heat map refers to at least one heat map for each of the configuration(s) (e.g., potential configuration(s)) and/or each of the grouping(s) of the configurations, whereby such a heat map is meant to indicate and/or show the usage and interdependency of infrastructure elements/components for each configuration and/or group of configurations. In some embodiments, the usage heat map may comprise at least one characteristic set for each configuration and/or group of configurations, whereby such a characteristic set may comprise organized data (such as organized within an index, within a table, and/or the like) of each of the configurations and each of the infrastructure elements/components affected within the entire computer system by each configuration. In some embodiments, the usage heat map may comprise a color indicator of which elements/components within the computer system are unable to handle the load of the configuration (e.g., by a red marking, a red highlighting, and/or the like), which are able to handle the load of the configuration with less optimal speed or efficiency (e.g., by an orange marking, orange highlighting, and/or the like), and which are able to handle the load of the configuration without burdening the speed, efficiency, or storage capacity of the component/element (e.g., by a green marking, a green highlighting, and/or the like), and/or the like. In some embodiments, such a usage heat map may be generated by a resource usage mapping component, such as that shown and described with respect to FIG. 5.

In some embodiments, the usage heat map may comprise a characteristic set of each of the data associated with each configuration(s) (e.g., potential configuration(s) and/or group of configuration(s)). Such a configuration set may be indexed and/or stored within a database.

As used herein, a desired result attribute refers to an indicator of a property for the configuration(s) (e.g., potential configuration(s) that shows whether each configuration(s) create a desired result. For instance, and where a configuration does not return an intended result (or negative result for what was intended), the system may generate a negative desired result attribute and store the negative desired result attribute with the configuration in its database. In some embodiments, and by of example, where a configuration returns an intended result (or positive result for what was intended), the system may generate a positive desired result attribute and store the positive desired result attribute with the configuration in its database. In some embodiments, the desired result attribute generated may additionally and/or alternatively depend on the interdependences of elements or components within the computer system and whether those interdependent elements or components also return a desired result (e.g., or do not return any adverse effects, such as but not limited to a result of the element or components no longer work, too high of storage capacity with the configuration effects, and/or the like). In some embodiments, the desired result attribute(s) may be generated by a stability assessment component, like that shown and described with respect to FIG. 5.

As used herein, a primary configuration identifier refers to a unique identifier or indication of the best or most optimal configuration(s) and/or group(s) of configurations. In some embodiments, the best or most optimal configuration(s) and/or group(s) of configurations may be based on the identified or received a potential configuration's (e.g., potential configuration's) objective. Such an objective may additionally be received or identified by the system based on receiving or identifying a user's input of the objective, whereby such a user may be a user associated with a client of the system (e.g., a user within the IT staff of a client), by the system itself (e.g., based on previous objectives associated with previous potential configurations), and/or the like. In some embodiments, the primary configuration identifier may be generated by a configuration cognition component, such as the one shown and described with respect to FIG. 5. In some embodiments, such a primary configuration identifier may be generated using a Naïve Bayes based machine learning model/algorithm, whereby such a machine learning model/algorithm may be continuously refined through continuously inputting the potential configurations and determining which potential configurations are the most optimal for the intended purpose or objective.

As used herein, a resource capacity instruction refers to an instruction, such as a set of coding in binary that the system and/or an associated computer system can understand, that requests a change in the underlying computer system and its associated elements or components. For instance, and where the system determines that a configuration (e.g., potential configuration) or group(s) of configurations require a change to the underlying computer system infrastructure (such as a change to storage capacity, memory, and/or the like, for specific software or hardware components affected by the configuration(s)), the system may generate a resource capacity instruction to recommend an increase or decrease in the component's storage or memory capacity. In some embodiments, the resource capacity instruction may be generated for each configuration and/or group of configurations, such that the system may determine an optimal configuration or group of configurations based on the increase or decrease in storage capacity (e.g., the less storage capacity used due to the configuration(s), the better processing speeds, the more efficient use of computing resources, and the better overall computing system environment). In some embodiments, the resource capacity instruction may be generated by an autonomous capacity planning component, like that shown and described with respect to FIG. 5.

Thus, and in some embodiments, the configuration delta processing engine output may comprise one of, a partial combination of, and/or a full combination of each of the potential configuration definition, a configuration group identifier, an anomaly, a usage heat map, a desired result attribute, a primary configuration identifier, and/or a resource capacity instruction.

As shown in block 310, the process flow 300 may include the step of applying the at least one configuration delta processing engine output to a configuration emulator engine. For example, the system may apply the at least one configuration delta processing engine output to a configuration emulator engine, whereby such a configuration emulator engine is configured to emulate or simulate the configuration(s) within the computer system infrastructure (including but not limited to its affected components and elements). As used herein, the configuration emulator engine is a computer service configured with at least one virtual computer system environment meant to mirror the computer system environment associated with the potential configuration(s), whereby each of the potential configuration(s) or group of configurations may be tested in the virtual environment and confirmed as optimal without executing the configuration(s) in the actual computer system environment.

In some embodiments, the configuration emulator engine may comprise a model simulation infrastructure stack and/or a retro service executor engine component. For example, and in some embodiments, the model simulation infrastructure stack may comprise a real time synchronizer component, a configuration playbook, at least one model environment stack, and/or an infrastructure manager component.

As used herein, such a real time synchronizer component is a computer service configured to keep the configuration emulator engine and its mirror components that are meant to emulate the computer system environment in sync with the latest potential configuration(s) received and/or identified. Additionally, and as used herein, the configuration playbook refers to a database or index of at least one existing configuration playbook(s) (e.g., script files from a library of existing configuration playbooks) comprising instructions of how to generate each model environment stack which implements each potential configuration. As used herein, the at least one model environment stack(s) refers to a model environment meant to emulate or mirror the computer system environment, such that the entire computer system environment is simulated in a controlled and isolated environment for the potential configurations to be run and executed. As used herein, the infrastructure manager component refers to a component comprising instructions for each of the at least one model environment stack(s) to properly mirror the computer system environment, including the production of the configuration(s) and/or group(s) of configurations in the mirrored environment. In some embodiments, and based on the production of the configuration(s) within the at least one model environment stack(s), the output of the at least one model environment stack(s) may be used to further refine and train the infrastructure manager component on how to execute and/or produce the configuration(s) and/or group(s) of configurations.

In some embodiments, the real time synchronizer component's output may be input to the configuration playbook, and the configuration playbook's output may be input to the at least one model environment stack. Similarly, and in some embodiments, the at least one model environment stack may additionally receive the output from the infrastructure manager component, and in some additional embodiments, the infrastructure manager component may receive the output from the at least one model environment stack. In this manner, each of the components within the configuration emulator engine may be used to train and refine each other component.

Additionally, and in some embodiments, the configuration emulator engine may comprise a retro service executor engine component, which is configured to execute the most optimal configuration(s) (e.g., potential configuration(s)) or group(s) of configurations based on the at least one configuration delta processing engine output. In this manner, the configuration emulator engine may be configured to emulate or mirror the identified potential configuration(s) and/or optimal grouping(s) of configurations—that were identified by the configuration delta processing engine—within a mirrored virtual computer system environment (e.g., similar to the mirror environment described with respect to the infrastructure manager component).

In some embodiments, and based on both the emulations of each of the potential configuration(s) and/or grouping(s) of configurations by the infrastructure manager component and the configuration emulator engine, the system may be able to determine which of the potential configuration(s) to execute in the actual computer system environment. For instance, and by comparing—by the configuration emulator engine—the optimal potential configuration(s) and/or optimal group(s) of configurations identified by the configuration delta processing engine and the mirrored potential configuration(s) or mirrored group(s) of configurations by the model simulation infrastructure stack component, the system can make an informed decision on which potential configuration or group(s) of configuration(s) are actually optimal. In some embodiments, and based on determining the actual optimal potential configuration(s) and/or group(s) of configurations, the configuration emulator engine may output at least one configuration simulation with the at least one actual optimal potential configuration and/or group(s) of configurations.

As shown in block 312, the process flow 300 may include the step of outputting—by the configuration emulator engine—at least one configuration simulation. For instance, the system—via the configuration emulator engine—may generate and output at least one configuration simulation indicating at least one optimal potential configuration and/or at least one optimal group of configurations. In some additional embodiments, the at least one configuration simulation may comprise all the data regarding the potential configuration(s) and/or group(s) of configurations identified by the configuration emulator engine, including but not limited to each of the affected elements or components within the mirrored computer system environment, any resource capacity instruction(s), and other such data generated by either the configuration delta processing engine and/or the configuration emulator engine.

In some embodiments, the at least one configuration simulation comprises at least one script. For example, the at least one configuration simulation may comprise at least one script file which comprises at least one instruction or a plurality of instructions for carrying out the configuration simulation in the actual computer system environment. Such a script file or plurality of script files may be used by the system to implement, execute, and publish the computer system environment with the configuration(s) of the configuration simulation(s), which have been identified by the system as optimal.

As shown in block 314, the process flow 300 may include the step of applying the at least one configuration simulation to a configuration management component, wherein the configuration management component comprises a component configuration distributed ledger. For example, the system may apply the at least one configuration simulation to a configuration management component, whereby the configuration management component is configured to keep track and record each of the configurations implemented within the computer system environment, including any previous configurations executed and the original component or element's version.

In some embodiments, such a configuration management component may comprise a distributed ledger, such as a component configuration distributed ledger for each of the software and hardware components within the computer system environment. In this manner, the configuration management component may keep a detailed record of each component within the computer system environment, including but not limited to each of the configurations executed and produced on each component, timestamps of each configuration, and/or the like. In some embodiments, the component configuration distributed ledger may comprise a block for each of the configurations for each component, whereby each block may comprise the timestamp for the production of each configuration on each component, the data of the configuration, the impacted components (such as the interdependent components) within the computer system environment for the configuration, and/or the like. In some embodiments, the configuration management component may comprise a plurality of component configuration distributed ledgers such that the plurality of components within the computer system environment have their own, individual component configuration distributed ledger.

As shown in block 316, the process flow 300 may include the step of updating the component configuration distributed ledger with the at least one configuration simulation. Thus, the system may update the component configuration distributed ledger(s) with at the at least one configuration simulation output by the configuration emulator engine. In some embodiments, each component configuration distributed ledger may additionally, and/or alternatively, comprise all the potential configuration(s) or group(s) of configuration analyzed by the system in separate branches of the component configuration distributed for the component within the computer system environment. In such embodiments, the chosen configuration that is actually implemented on component may be indicated within the component configuration distributed ledger and each additional configuration on the component may be directly linked to the previous block of the executed configuration(s). Similarly, the non-chosen configuration(s) (e.g., non-optimal potential configuration(s)) may branch off from the previously implemented configuration, but not have any future branches of configurations depend from or linked to the non-executed configuration block.

In some embodiments, the component configuration distributed ledger(s) may be transmitted and/or output to an IT infrastructure system for production, depending on which configurations are determined to be the most optimal. Thus, and in some embodiments, the production of the optimal configuration(s) may be executed after the component configuration distributed ledger is updated.

FIG. 4 illustrates a process flow 400 for updating the component configuration distributed ledger, in accordance with an embodiment of the disclosure. In some embodiments, a system (e.g., similar to one or more of the systems described herein with respect to FIGS. 1A-1C and 2) may perform one or more of the steps of process flow 400. For example, a system (e.g., the system 130 described herein with respect to FIG. 1A-1C) may perform the steps of process 400.

In some embodiments, and as shown in block 402, the process flow 400 may include the step of identifying a plurality of validating entities within a distributed network, wherein the plurality of validating entities is associated with at least one system component. For example, the system may identify a plurality of validating entities based on identifying user accounts that should validate the configuration(s) before they are executed or implemented on the actual component system environment. In some embodiments, the user accounts for validation may dynamically and automatically change based on the component(s) or element(s) affected by the specific configuration. In this manner, the system may identify a plurality of validating entities that should be able to view the configuration simulation(s) of step 310 before the configuration simulation is implemented within the computer system environment.

In some embodiments, and as shown in block 404, the process flow 400 may include the step of generating a consensus algorithm for the component configuration distributed ledger, wherein the consensus algorithm comprises a consensus threshold. For instance, the system may generate a consensus algorithm indicating how many positive indicators from the validating entities are required in order to execute or implement the configuration(s) of the configuration simulation(s). Thus, and by way of example, the system may be configured to generate and transmit an interface component requesting a positive or negative indication from each entity of the validating entities, whereby the interface comment may be transmitted to a user device associated with at least one validating entity. In this manner, the interface component may be used to configure the graphical user interface (GUI) of each user device with the data of the configuration simulation to show the user how the configuration of the configuration simulation will work in the overall computer system environment.

In some embodiments, the consensus algorithm may comprise a consensus threshold, which must be met by the plurality of validation responses before the configuration of the configuration simulation can be executed and produced. In some embodiments, such a consensus threshold may comprise a percentage of all the validating entities identified by the system (e.g., 50% of the validation responses must comprise a positive indication, and/or 50% of the validating entities must comprise a 50% of positive indications).

In some embodiments, and as shown in block 406, the process flow 400 may include the step of receiving a plurality of validation responses from the plurality of validating entities, wherein the plurality of validation responses is compared to the consensus threshold. For example, the system may receive a plurality of validation responses (e.g., comprising a positive indication or negative indication) of whether the configuration(s) of the configuration simulation(s) are acceptable, including their effects on the entire computer system environment. Additionally, the plurality of validation response may be compared against the consensus threshold in order to determine whether the number of positive indications received for the plurality of validation responses meet or exceed the amount required by the consensus threshold (e.g., 51% of the validation responses comprising a positive indication may meet the consensus threshold when the consensus threshold is 50%).

In some embodiments, and as shown in block 408, the process flow 400 may include the step of updating—in an instance where the plurality of validation responses meet or exceed the consensus threshold—the component configuration distributed ledger with the at least one potential configuration. For instance, the system may update the component configuration distributed ledger with the at least one configuration simulation, like the process described herein with respect to block 314.

In some embodiments, the configuration management component may comprise at least one smart contract associated with the at least one potential configuration, and the at least one smart contract triggers the updating of the component configuration distributed ledger. For instance, the smart contract, upon identifying a potential configuration(s), may identify whether the plurality of validation responses have met the consensus threshold, the system may automatically update the component configuration distributed ledger with the component simulation data.

FIG. 5 illustrates an exemplary computing environment 500 with associated components for securing and emulating computing system configurations, in accordance with an embodiment of the disclosure. In some embodiments, a system (e.g., similar to one or more of the systems described herein with respect to FIGS. 1A-1C and 2) may perform one or more of the system environment 500. For example, a system (e.g., the system 130 described herein with respect to FIG. 1A-1C) may perform the system environment 500.

For instance, and as shown in the system environment 500, the system may comprise at least an information technology infrastructure 502, a configuration delta detector 504, a configuration delta processing engine 506, a configuration emulator engine 518, a configuration management component 524, and a component configuration distributed ledger 526.

In some embodiments, the system may receive and/or identify the components and elements of the computer system environment at the information technology (IT) infrastructure 502. In some embodiments, the system may identify the potential configuration(s) from the IT infrastructure 502, whereby the IT infrastructure may be configured to receive a potential configuration(s) identifier(s) from a client of the system, by the system itself, and/or the like. In some embodiments, the IT infrastructure 502 may receive the potential configuration(s) from a user device (such as a user device associated with a client of the system) and may parse the data of each potential configuration within the IT infrastructure 502 before transmitting the potential configuration data to the configuration delta detector 504.

Additionally, and in some embodiments, the configuration delta detector 504 may be configured to determine each of the configuration deltas for each potential configuration. Once the configuration delta(s) has been determined, the configuration delta(s) may be input to the configuration delta processing engine 506 which may, in some embodiments, may comprise a simulation aggregator component 508, an elastic data feed component 515, a resource usage mapping component 516, a stability assessment component 510, a configuration cognition component 512, and/or an autonomous capacity planning component 514. Additionally, and as shown in the system environment 500, the arrows within the configuration delta processing engine may show an exemplary embodiment of each of the inputs and outputs for each component (e.g., configuration delta processing engine 506 which may, in some embodiments, may comprise a simulation aggregator component 508, an elastic data feed component 515, a resource usage mapping component 516, a stability assessment component 510, a configuration cognition component 512, and/or an autonomous capacity planning component 514) and how they are used within the configuration delta processing engine. Such an embodiment is meant to be exemplary only and a person of skill in the art will understand that other embodiments of inputs and outputs are considered and can be used herein.

Additionally, and upon generating the output by the configuration delta processing engine 506, the configuration delta processing engine output may be input to a configuration emulator engine 518 for mirroring the potential configuration(s) and group(s) of configurations to determine the optimal potential configurations and optimal group(s) of configurations to be executed. In some embodiments, the configuration emulator engine 518 may additionally comprise a model simulation infrastructure stack component 520 and/or a retro service executor engine component 522.

Once the configuration simulation(s) of the configuration emulator engine 518 has been generated, the configuration simulation(s) may be output to the configuration management component 524. Such a configuration management component 524 may track and record each of the configuration(s) actually implemented on the computer system environment through at least one component configuration distributed ledger 526. Additionally, and upon recording the configuration(s) actually implemented in the computer system environment (and in some embodiments, configuration(s) not implemented but considered), the chosen configuration(s) may be output back to the IT infrastructure 502 for actual execution and implementation in the computer system environment.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for securing and emulating computing system configurations, the system comprising:
a memory device with computer-readable program code stored thereon;
at least one processing device, wherein executing the computer-readable code is configured to cause the at least one processing device to perform the following operations:
identify at least one potential configuration for at least one system component;
generate at least one configuration delta for the at least one potential configuration;
apply the at least one configuration delta to a configuration delta processing engine;
generate, by the configuration delta processing engine, at least one configuration delta processing engine output;
apply the at least one configuration delta processing engine output to a configuration emulator engine;
output, by the configuration emulator engine, at least one configuration simulation;
apply the at least one configuration simulation to a configuration management component, wherein the configuration management component comprises a component configuration distributed ledger; and
update the component configuration distributed ledger with the at least one configuration simulation.

2. The system of claim 1, wherein the configuration delta processing engine comprises at least one of a simulation aggregator component, an elastic data feed component, a resource usage mapping component, a stability assessment component, a configuration cognition component, or an autonomous capacity planning component.

3. The system of claim 1, wherein the at least one configuration delta processing engine output comprises at least one of a potential configuration definition, a configuration group identifier, an anomaly, a usage heat map, a desired result attribute, a primary configuration identifier, or a resource capacity instruction.

4. The system of claim 1, wherein the configuration emulator engine comprises at least one of a real time synchronizer component, a configuration playbook, a model environment stack, or an infrastructure manager component.

5. The system of claim 1, wherein the at least one configuration simulation comprises at least one script.

6. The system of claim 1, wherein the at least one configuration delta comprises at least one a base identifier, and wherein the base identifier is associated with a new system component or an updated system component.

7. The system of claim 1, wherein updating the component configuration distributed ledger with the at least one configuration simulation comprises:
identify a plurality of validating entities within a distributed network, wherein the plurality of validating entities is associated with the at least one system component;
generate a consensus algorithm for the component configuration distributed ledger, wherein the consensus algorithm comprises a consensus threshold; and
receive a plurality of validation responses from the plurality of validating entities, wherein the plurality of validation responses is compared to the consensus threshold,
update, in the instance where the plurality of validation responses meet or exceed the consensus threshold, the component configuration distributed ledger with the at least one configuration simulation.

8. The system of claim 7, wherein the configuration management component comprises at least one smart contract associated with the at least one potential configuration, and wherein the at least one smart contract triggers the updating of the component configuration distributed ledger.

9. A computer program product for securing and emulating computing system configurations, wherein the computer program product comprises at least one non-transitory computer-readable medium having computer-readable program code portions embodied therein, the computer-readable program code portions which when executed by a processing device are configured to cause the processor to perform the following operations:
identify at least one potential configuration for at least one system component;
generate at least one configuration delta for the at least one potential configuration;
apply the at least one configuration delta to a configuration delta processing engine;
generate, by the configuration delta processing engine, at least one configuration delta processing engine output;
apply the at least one configuration delta processing engine output to a configuration emulator engine;
output, by the configuration emulator engine, at least one configuration simulation;
apply the at least one configuration simulation to a configuration management component, wherein the configuration management component comprises a component configuration distributed ledger; and
update the component configuration distributed ledger with the at least one configuration simulation.

10. The computer program product of claim 9, wherein the configuration delta processing engine comprises at least one of a simulation aggregator component, an elastic data feed component, a resource usage mapping component, a stability assessment component, a configuration cognition component, or an autonomous capacity planning component.

11. The computer program product of claim 9, wherein the at least one configuration delta processing engine output comprises at least one of a potential configuration definition, a configuration group identifier, an anomaly, a usage heat map, a desired result attribute, a primary configuration identifier, or a resource capacity instruction.

12. The computer program product of claim 9, wherein the configuration emulator engine comprises at least one of a real time synchronizer component, a configuration playbook, a model environment stack, or an infrastructure manager component.

13. The computer program product of claim 9, wherein the at least one configuration simulation comprises at least one script.

14. The computer program product of claim 9, wherein the at least one configuration delta comprises at least one a base identifier, and wherein the base identifier is associated with a new system component or an updated system component.

15. A computer implemented method for securing and emulating computing system configurations, the computer implemented method comprising:
identifying at least one potential configuration for at least one system component;
generating at least one configuration delta for the at least one potential configuration;
applying the at least one configuration delta to a configuration delta processing engine;
generating, by the configuration delta processing engine, at least one configuration delta processing engine output;
applying the at least one configuration delta processing engine output to a configuration emulator engine;
outputting, by the configuration emulator engine, at least one configuration simulation;
applying the at least one configuration simulation to a configuration management component, wherein the configuration management component comprises a component configuration distributed ledger; and
updating the component configuration distributed ledger with the at least one configuration simulation.

16. The computer implemented method of claim 15, wherein the configuration delta processing engine comprises at least one of a simulation aggregator component, an elastic data feed component, a resource usage mapping component, a stability assessment component, a configuration cognition component, or an autonomous capacity planning component.

17. The computer implemented method of claim 15, wherein the at least one configuration delta processing engine output comprises at least one of a potential configuration definition, a configuration group identifier, an anomaly, a usage heat map, a desired result attribute, a primary configuration identifier, or a resource capacity instruction.

18. The computer implemented method of claim 15, wherein the configuration emulator engine comprises at least one of a real time synchronizer component, a configuration playbook, a model environment stack, or an infrastructure manager component.

19. The computer implemented method of claim 15, wherein the at least one configuration simulation comprises at least one script.

20. The computer implemented method of claim 15, wherein the at least one configuration delta comprises at least one a base identifier, and wherein the base identifier is associated with a new system component or an updated system component.
